(19) United States
(12) Patent Application Publication
(10) Pub. No.: US 2009/0296140 A1
(43) Pub. Date: Dec. 3, 2009

(54) Printer controller

(75) Inventors: Koichi SUGIYAMA, Anjo-shi (JP); Yasuhisa ICHIKAWA, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/462,727

(22) Filed: Aug. 7, 2009

Related U.S. Application Data
(63) Continuation-in-part of application No. PCT/JP08/53104, filed on Feb. 22, 2008.

(30) Foreign Application Priority Data
Feb. 26, 2007 (JP) 2007-045205

(51) Int. Cl. G06F 15/00

(52) U.S. Cl. 358/1.15; 340/10.1

(57) ABSTRACT

A printer server obtains request information relating to RFID label production of the operator output from a terminal, selects a printer that can deal with tag attribute information of an RFID tag circuit element or communication type information contained in the request information from among a plurality of RFID label printers and outputs a signal corresponding to the request information to the selected RFID label printer.

### CROSS-REFERENCE TO RELATED APPLICATION

This is a CIP application PCT/JP2008/53104, filed Feb. 22, 2008, which was not published under PCT article 21(2) in English and claims the benefits of Japanese Patent application No. 2007-045205 filed Feb. 26, 2007.

### BACKGROUND OF THE INVENTION

1. Field of the Invention

The present invention relates to a printer controller configured to control a plurality of printers connected to a network.

2. Description of the Related Art

Recently, there has been a practice in which a plurality of operation terminals such as a PC, that is a Personal Computer, and a plurality of printers are connected through a network such as a LAN, that is a Local Area Network, so as to allow a plurality of operators to share a single printer, to use a plurality of printers separately. At this time, the operation terminal and the plurality of printers are connected through a printer controller in general, and the plurality of printers is controlled by the printer controller.

As a prior art reference of the printer controller, the one described in JP, A, 6-4239 is known, for example. This printer controller is configured such that when receiving print data from an operator, that is a client, the printer controller discriminates an operation state of the printer specified by the operator and, if the printer is malfunctioning or in a busy state due to a printing command from another operator, switches the printer to output the print data to another printer.

In the above prior art reference, the operator should specify a printer suitable for his or her needs from among a plurality of printers connected to the network. The operator's needs at this time can be diversified such as a printing mode to be printed by the operator including paper size, color or monochromatic printing, double-sided or one-sided printing or closeness of an installed position of the printer to the operator. Therefore, if the printer according to the needs is to be specified each time in printing, the printing setting or functions of each printer needs to be checked, which requires labor of the operator.

### SUMMARY OF THE INVENTION

The present invention has an object to provide a printer controller than can reduce labor of an operator by making a printer suitable for the needs of the operator automatically selectable from among the plurality of printers.

### BRIEF DESCRIPTION OF THE DRAWING

FIG. 1 is a system configuration diagram illustrating an RFID tag manufacturing system provided with a printer server, which is an embodiment of a printer controller of the present invention.

FIG. 2 is a conceptual configuration diagram conceptually illustrating an entire configuration of an RFID label printer.

FIG. 3 is a flowchart illustrating a control procedure executed by a control circuit when an RFID label provided with the RFID tag circuit element is produced by the RFID label printer.

FIG. 4 is a flowchart illustrating a detailed procedure of Step S300.

FIG. 5 is a functional block diagram illustrating a functional configuration of a printer server.

FIG. 6 is a flowchart illustrating a control procedure executed by a control circuit of the printer server.

FIG. 7 conceptually illustrates a priority table.

FIG. 8 conceptually illustrates a table for reference items when priorities are set.

FIG. 9 is a flowchart illustrating a detailed procedure of Step S500.

FIG. 10 conceptually illustrates a status table.

FIG. 11 conceptually illustrates a table for an RFID label production history.

### DETAILED DESCRIPTION OF THE PREFERRED EMBODIMENTS

An embodiment of the present invention will be described below referring to the attached drawings. This embodiment is an embodiment when the present invention is applied to an RFID tag manufacturing system.

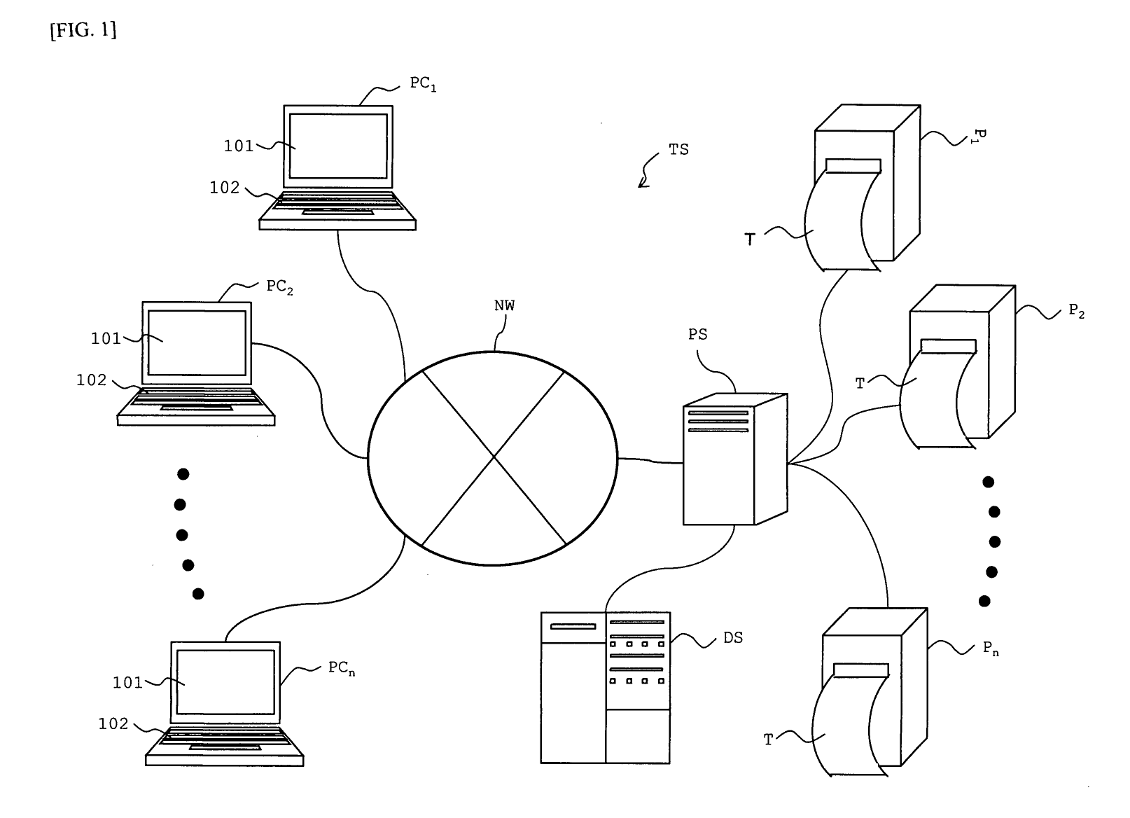

FIG. 1 is a system configuration diagram illustrating an RFID tag manufacturing system provided with a printer server, which is an embodiment of the printer controller of the present invention.

In an RFID tag manufacturing system TS shown in FIG. 1, a printer server PS as a printer controller is connected to a plurality of terminals PC₁ to PCₙ as an operation terminal through a wired or wireless communication line NW. Hereinafter the terminals PC₁ to PCₙ are respectively described as “terminal PC” as appropriate. Each of the terminals PC₁ to PCₙ is a personal computer, for example, and has a display portion 101 configured to display various input screens and an operation portion 102 for input made by an operator. Also, the printer server PS as a printer controller has a printing function for printing print data on a tag tape 303 (which will be described later) and a radio communication function for information transmission and reception via radio communication with an RFID tag circuit element To (which will be described later) provided at the tag tape 303 and is connected to the plurality of an RFID label printers P₁ to Pₙ configured to produce an RFID label T and also connected to a data server DS capable of registration of various data.

The RFID label printers P₁ to Pₙ as printers have a communication function and a printing function set in advance, respectively, and is configured to produce an RFID label T corresponding to each printer when a cartridge (which will be described later) set in advance is attached. Hereinafter the RFID label printers P₁ to Pₙ are respectively described as “RFID label printer P” as appropriate. For example, in a printer Pₙ, printing with high resolution is carried out and radio communication by Type C in ISO/IEC 18000-6 is conducted in an UHF band so that an RFID label T with a large label width and a label length is produced. Also, in the printer Pₙ₋₁, printing with low resolution but high speed is carried out and radio communication by ISO/IEC 18000-3 mode2 in a HF band is conducted so that an RFID label T with a small label width and label length is produced.

In the RFID tag manufacturing system TS with the above configuration, when an RFID label production start instruction is input by the operator using the operation portion 102 of the terminal PC, the RFID label T desired by the operator can be produced, and an RFID label printer P optimal for the needs the operator is selected by the printer server PS, and the RFID label T is produced by the selected RFID label printer P (details will be described later).

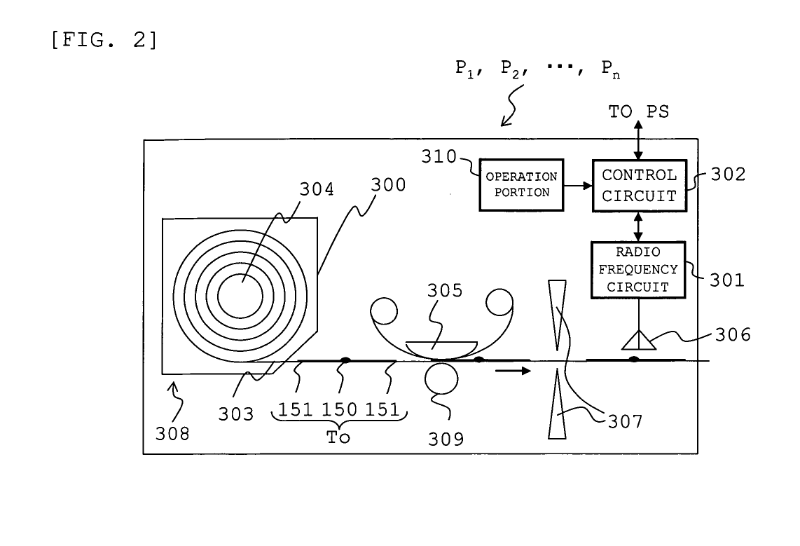

FIG. 2 is a conceptual configuration diagram conceptually illustrating an entire configuration of the RFID label printer P.

In FIG. 2, the RFID label printer P has an operation portion 310, a cartridge holder 308, a print head 305, an antenna 306, a radio frequency circuit 301, a control circuit 302, a cutter 307, and a feeding device 309. The operation portion 310 is to be operated by an operator. A cartridge 300 continuously supplying a tag tape 303 as an object to be printed and tag medium wound around a roll 304 of a tape with RFID tags can be detachably attached to the cartridge holder 308. The print head 305 as a printing device performs desired printing on an area corresponding to each RFID tag circuit element To in a print-receiving tape layer (not shown) provided in the tag tape 303 fed out of the roll 304 of a tape with RFID tags. The antenna 306 as a communication device transmits and receives information with the RFID tag circuit element To via radio communication. The cutter 307 cuts the tag tape 303 for which printing on the tag tape 303 and information writing in the RFID tag circuit element To have been finished to a predetermined length to have the RFID label T. The feeding device 309 feeds the tag tape 303 under control by the control circuit 302, provided opposite to the print head.

RFID tag circuit elements To are provided on the tag tape 303 with a predetermined interval. Actually, the tag tape 303 is wound in a spiral state but simplified and shown with a concentric circle.

Though detailed description will be omitted, the radio frequency circuit 301 and the control circuit 302 creates access information to an IC circuit part 150 of the RFID tag circuit element To, transmits it to the RFID tag circuit element To through the antenna 306, and writes information in the IC circuit part 150 of the RFID tag circuit element To. The control circuit 302 is connected to the printer server PS and is capable of information transmission and reception.

The RFID label printer conducting communication in the UHF band is used as an example for description in the above, but those conducting communication in the HF band are also included in the RFID label printers P₁ to Pₙ as described above. With these printers, though not particularly described using the drawings, a transmitting circuit, a receiving circuit, and an antenna sharing device are provided instead of the radio frequency circuit 301. The UHF band is 915 MHz and the HF band is 13.56 MHz, for example.

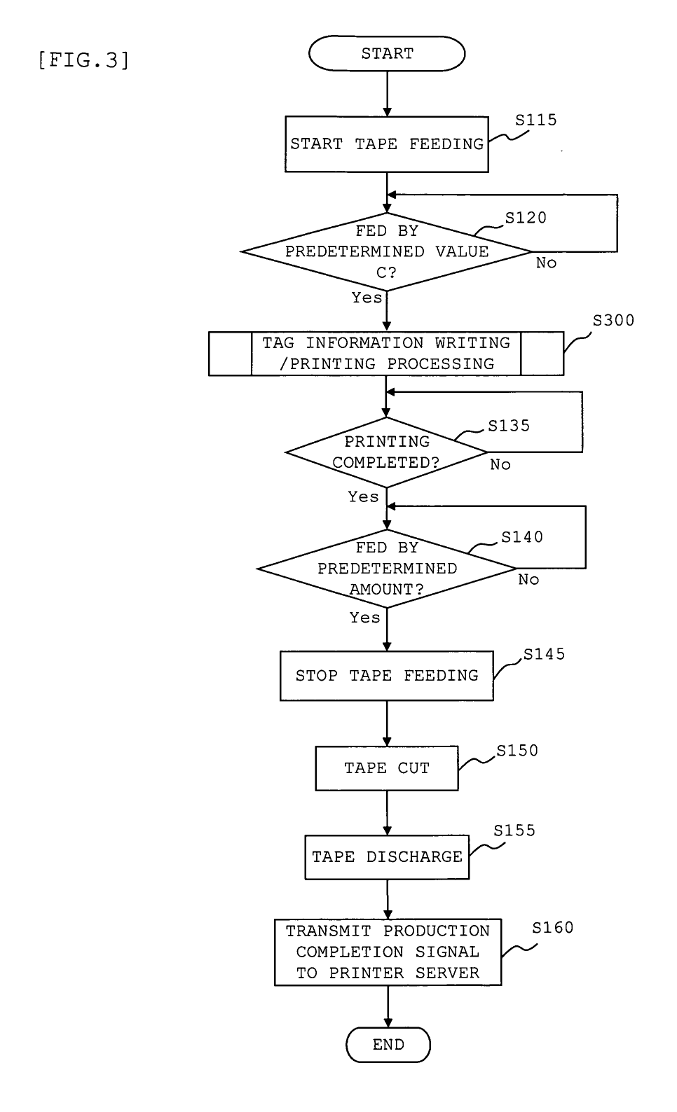

FIG. 3 is a flowchart illustrating a control procedure executed by the control circuit 302 when the RFID label T provided with the RFID tag circuit element To is produced by the RFID label printer P.

In FIG. 3, first, at Step S115, a control signal is output to the feeding device 309, for example, so that the tag tape 303 is fed out of the roll 304 of a tape with RFID tags by a driving force of a motor to drive cartridge shaft (not shown).

After that, the routine goes to Step S120, where it is determined whether or not the tag tape 303 has been fed by a predetermined value C. For example, the value C is a feeding distance by which RFID tag information writing in the preceding RFID tag circuit element To is finished and the subsequent RFID tag circuit element To reaches a position substantially opposing the antenna 306. This feeding distance determination may be made by detecting marking provided on the tag tape 303 by a known tape sensor (not shown), for example. If the determination is satisfied, the routine goes to Step S300.

At Step S300, tag information writing and printing processing is carried out. That is, request information as a printing instruction signal including print data and RFID tag information transmitted from the printer server PS is received, RFID tag information is written in the RFID tag circuit element To on the tag tape 303 on the basis of the signal, and the print data is printed by the print head 305 on a corresponding area on the tag tape 303 (detailed procedure will be described later). When Step S300 is finished, the routine goes to Step S135.

At Step S135, after it is checked whether or not a printing on a area corresponding to the RFID tag circuit element To as a processing target at this time in the tag tape 303 has been all completed, and then, the routine goes to Step S140.

At Step S140, it is determined if all the tag tape 303 has been further fed by a predetermined amount. The predetermined amount is, for example, a feeding distance by which all the RFID tag circuit element To and the print area as a target exceeds the cutter 307 by a predetermined length as a margin amount or not. A feeding distance determination at this time can be also made similarly to the above-described Step S120. If the determination is satisfied, the routine goes to Step S145.

At Step S145, a control signal is output to the feeding device 309, driving of the motor to drive cartridge shaft is stopped, and feeding-out and feeding of the tag tape 303 from the roll 304 of a tape with RFID tags are stopped.

After that, at Step S150, a control signal is output to a solenoid driving circuit, not shown, for example, so as to drive a solenoid for cutter (not shown), and the tag tape 303 is cut off by the cutter 307. As described above, at this time, whole of the tag tape 303 including the RFID tag circuit element To and the print area to be processed, for example, has sufficiently exceeded the cutter 307, and by means of a cutting by the cutter 307, the label-shaped RFID label T for which an RFID tag information has been written in the RFID tag circuit element To and the corresponding desired printing has been performed is produced.

After that, the routine goes to Step S155, where the RFID label T produced in a label shape at Step S150 is discharged to an outside of the RFID label printer P. Otherwise, a separately provided discharge roller may be driven and controlled or an operator may manually pull it out.

At the subsequent Step S160, an RFID label production completion signal indicating that a production of the RFID label T has been completed is transmitted to the printer server PS. Then, this flow is finished.

Note that the above flow does not limit the present invention to a procedure shown in the flow, but addition and deletion or change of order of the procedures may be made within a range not departing from a gist and technical idea of the present invention.

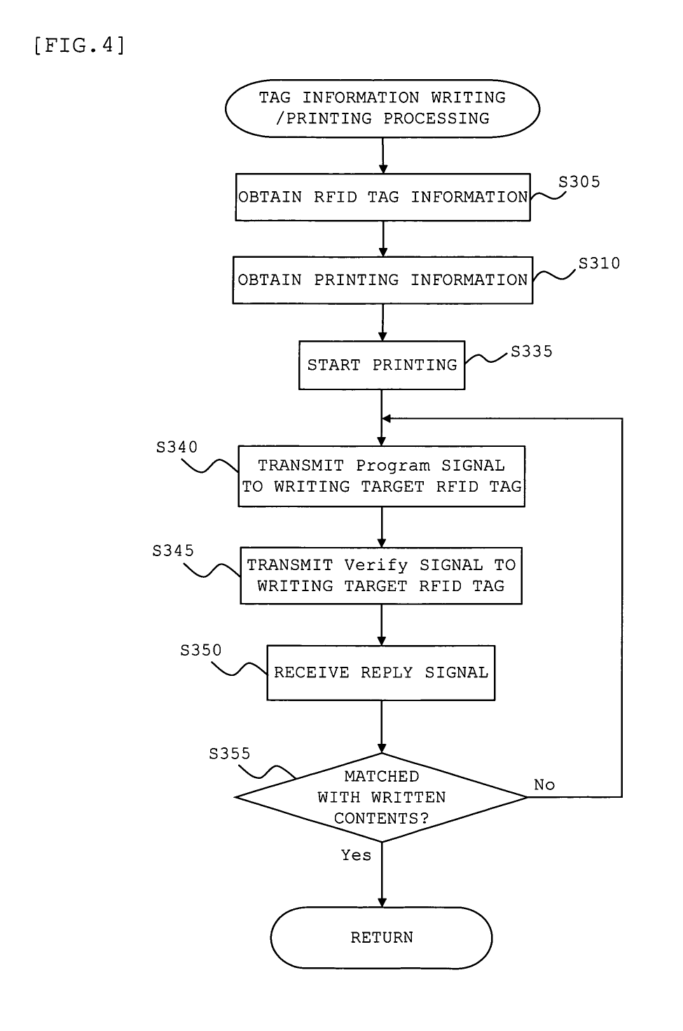

FIG. 4 is a flowchart illustrating a detailed procedure of the above-described Step S300.

In FIG. 4, first, at Step S305, request information as a printing instruction signal transmitted from the printer server PS is received, and RFID tag information included therein is obtained.

After that, at Step S310, a print data included in the request information received from the printer server PS is obtained.

After that, the routine goes to Step S335, where a control signal is output to a print-head driving circuit, not shown, for example, so as to electrify the print head 305 so that printing of the print data obtained at Step S310 is started on the area corresponding to the RFID tag circuit element To as a processing target in the tag tape 303.

Subsequently, the routine goes to Step S340, a “Program” command signal to write desired data in the memory part 155 (not shown) of the RFID tag circuit element To is generated and transmitted to the RFID tag circuit element To as an information writing target through the radio frequency circuit 301, and information is written in the memory part 155. A “Program” command signal at this time includes the RFID tag information obtained at Step S305.

After that, at Step S345, a “Verify” command signal to check success or failure of a communication result is generated and transmitted to the RFID tag circuit element To as an information writing target through the radio frequency circuit 301, and a reply is prompted.

After that, at Step S350, a reply signal transmitted from the RFID tag circuit element To as a writing target in response to a “Verify” command signal is received through the antenna 306 and taken in through the radio frequency circuit 301.

Subsequently, at Step S355, on the basis of a reply signal, the information stored in the RFID tag circuit element To is checked and it is determined whether or not predetermined information transmitted above has been normally stored in the RFID tag circuit element To. If the determination is satisfied, this flow is finished. As a result, information writing in the RFID tag circuit element To as a writing target is completed, and this flow is finished. If the determination is not satisfied, the routine returns to Step S340, where a similar procedure is repeated.

With the above routine, the corresponding information can be written in the RFID tag circuit element To as a writing target on the tag tape 303, and a desired printing can be performed on a corresponding print area on the tag tape 303.

The above flow does not limit the present invention to the procedure shown in the flow, but addition and deletion or change of order of procedures such as switching of the procedures of Step S305 and Step S310 to each other, for example, may be made within a range not departing from a gist and technical idea of the present invention.

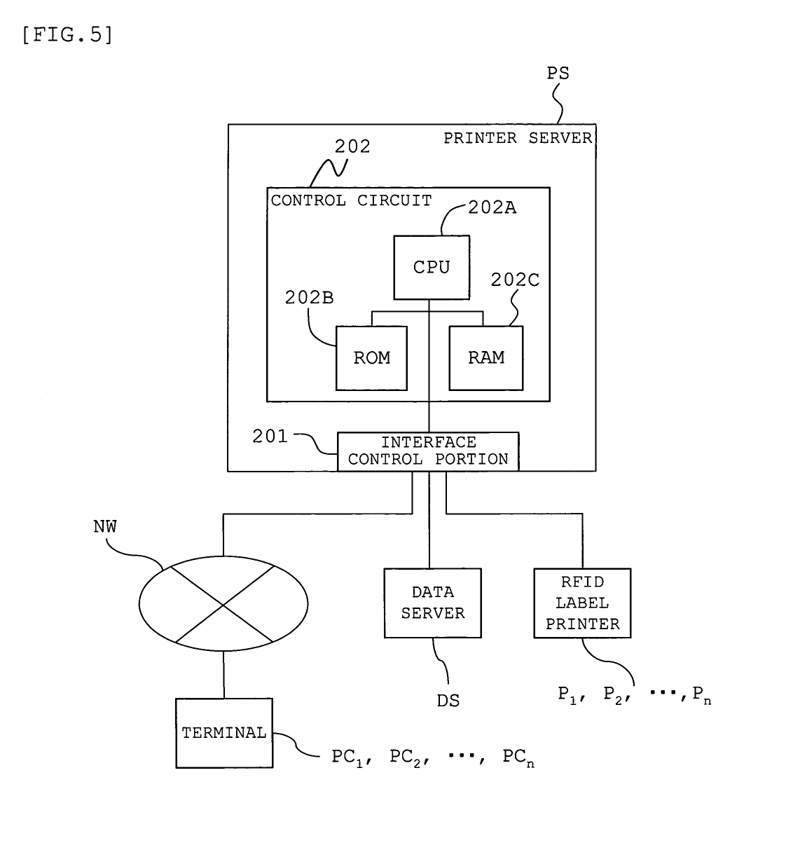

FIG. 5 is a functional block diagram illustrating a functional configuration of the printer server PS.

In FIG. 5, the printer server PS has an interface control portion 201 configured to transmit and receive a signal with the terminals PC₁ to PCₙ, the data server DS, and the RFID label printers P₁ to Pₙ and a control circuit 202. The control circuit 202 is a so-called microcomputer, including a CPU 202A, which is a central processing unit, a ROM 202B, a RAM 202C so as to process signals according to a program stored in the ROM 202B in advance, while using a temporary storage function of the RAM 202C.

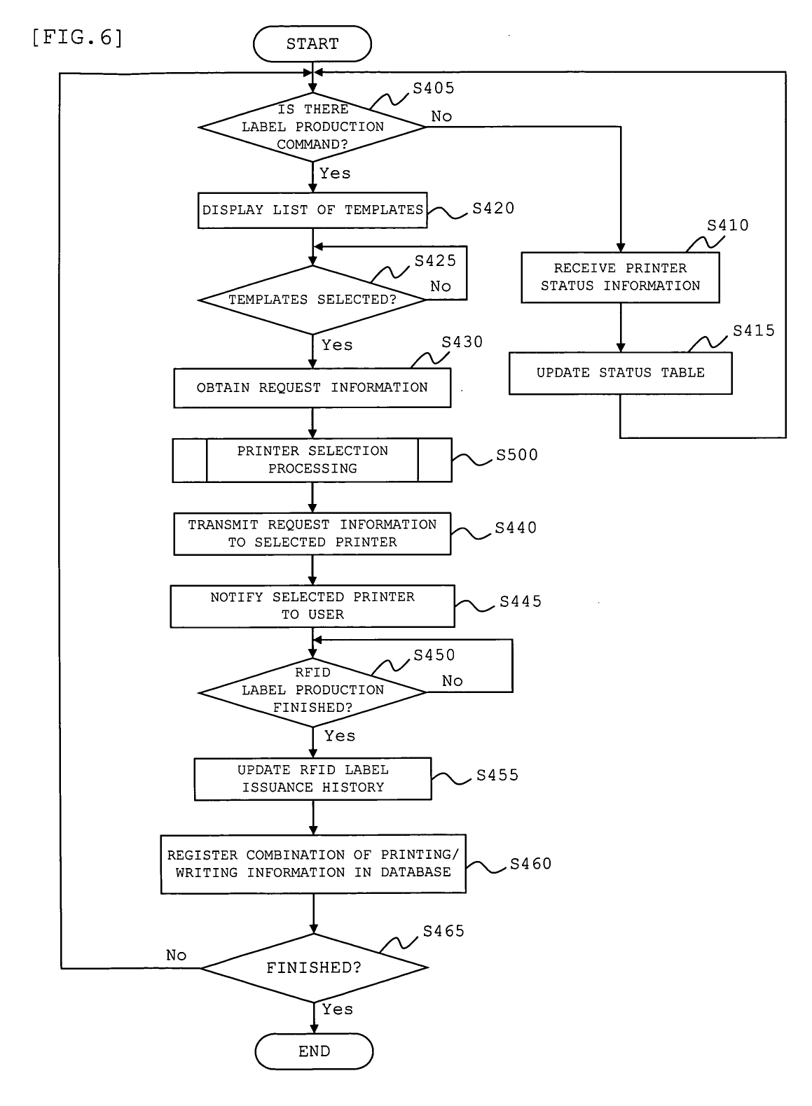

FIG. 6 is a flowchart illustrating a control procedure executed by the control circuit 202 of the printer server PS. This flow is started when the printer server PS is powered on, for example.

First, at Step S405, when an operator inputs an RFID label production start instruction using the operation portion 102 of the terminal PC, it is determined whether or not the RFID label production command signal has been input from the terminal PC through the communication line NW. If an RFID label production command signal has not been input, the determination is not satisfied, and the routine goes to Step S410.

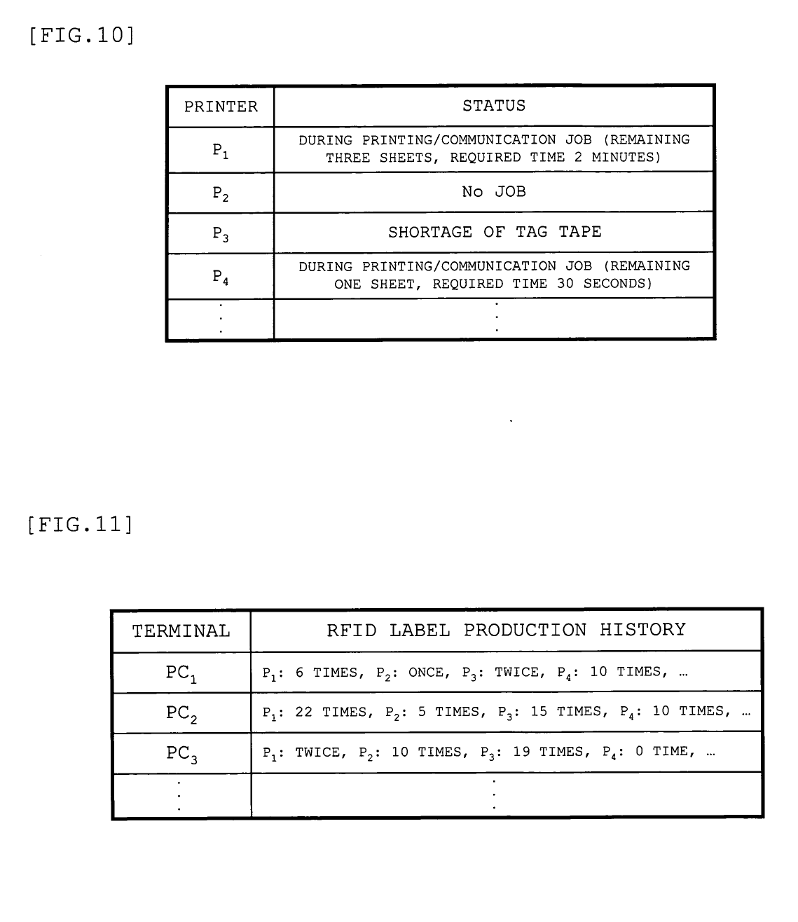

At Step S410, status information transmitted from each printer P is obtained. Status information is operation status information indicating an operation status of each printer P such as a job status on whether or not printing and tag information is received from the printer server PS and the RFID label is being produced, if the RFID label is being produced, how much time is required till a production is finished, a status in which a tag tape of the attached cartridge 300 is cut out and a label can not be produced, and a malfunction status due to a failure (See FIG. 10, which will be described later), and each printer P transmits the status information to the printer server PS at a predetermined cycle.

At the subsequent Step S415, the status information of each printer P obtained at Step S410 is stored in an appropriate storage device, as a status table (See FIG. 10, which will be described later). The storage device includes the RAM 202C, for example. Otherwise, the storage device may be the data server DS. Then, the routine returns to the preceding Step S405.

As described above, if the operator does not give the label production command, while Step S405 to Step S415 are repeated, a status table made up of the status information of each printer P is updated. Then, if the label production command signal is input while Step S405 to Step S415 are repeated, the determination at Step S405 is satisfied, and the routine goes to Step S420.

At Step S420, a display signal is transmitted to the terminal PC to which the label production command signal has been transmitted through the interface control portion 201 and the communication line NW. As a result, on the display portion 101 of the terminal PC, a plurality of templates of the RFID label T stored in advance in an appropriate location of the printer server PS, in detail the RAM 202C, for example, is displayed. In each template, request information requested by the operator in producing the RFID label T, that is, label shape such as width, length, type of communication used for information transmission and reception with the RFID tag circuit element To, such as communication parameter, communication frequency, protocol, attributes of the RFID tag circuit element To such as attribute parameter, antenna sensitivity, memory capacity, label printing mode such as font, character color, presence or absence of background, are set in advance. Further, each template is associated with the RFID label printer P, that is, at least one unit of P₁ to Pₙ or plural units satisfying the request information, in other words, the RFID label printer P that can produce the RFID label T corresponding to the template. That is, when the operator selects a desired template from among a plurality of templates, the operator's request information such as shape, communication type, tag attribute, printing mode is determined. Note that the above request information is an example, and other request elements may be included. Also, each template has an input portion for required data such as text information and RFID tag information, and when the operator inputs text information and the RFID tag information in an input portion, a print data to be printed on a label and RFID tag information to be written in the RFID tag circuit element To are determined.

At the subsequent Step S425, it is determined if the operator has selected a template or not. This determination is made by detecting whether or not a selection signal as printing operation signal corresponding to a selection of the template has been input from the terminal PC through the communication line NW. If the template selection has been made, the determination is satisfied, and the routine goes to the subsequent Step S430.

At Step S430, the request information such as shape, communication type, tag attribute, printing mode contained in a selection signal corresponding to a selection of the template, transmitted from the terminal PC, is obtained. The request information includes a print data input by the operator in the input portion of the template and the RFID tag information.

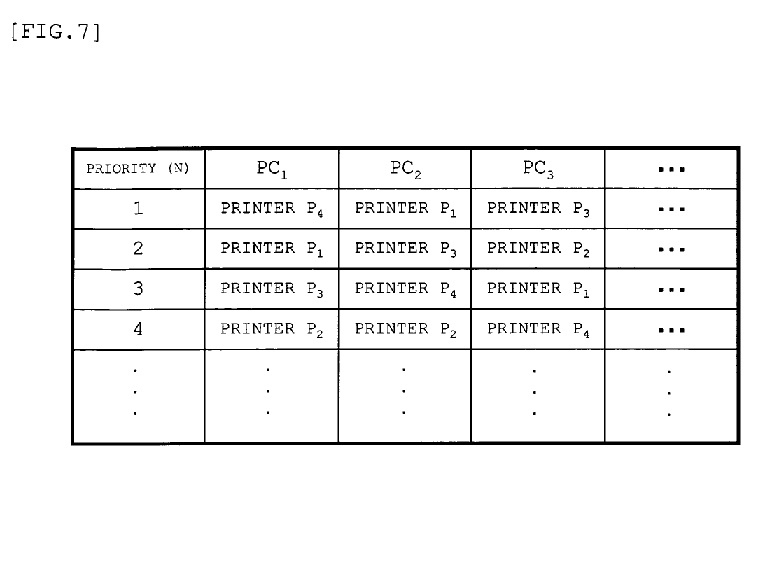

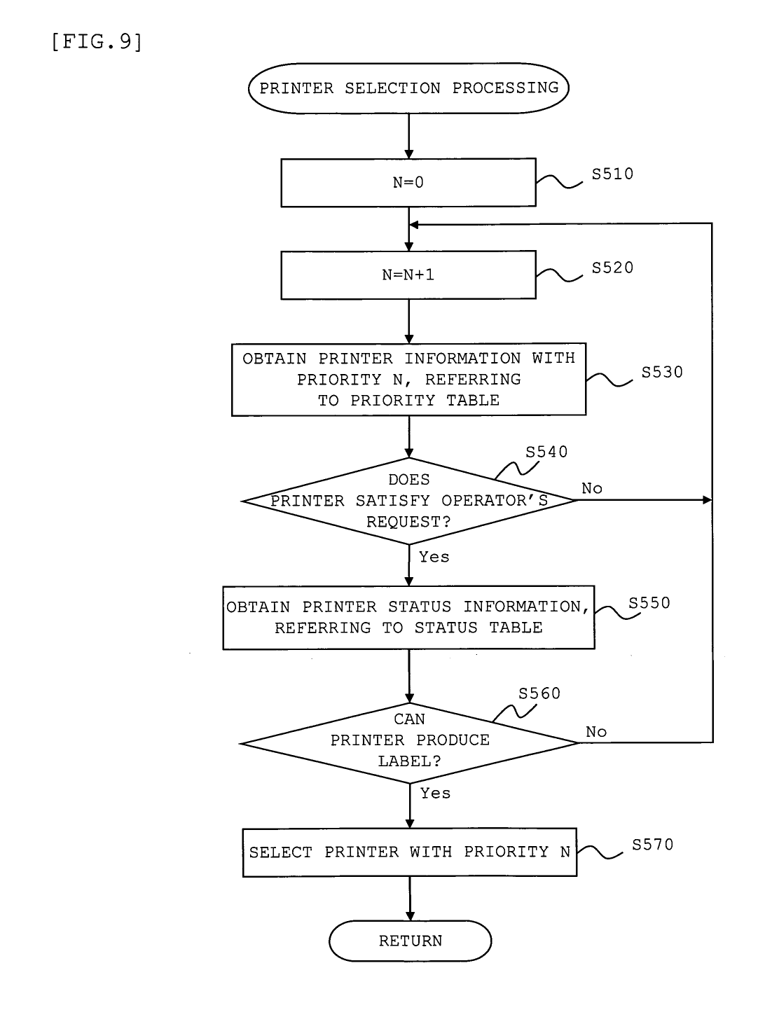

At the subsequent Step S500, on the basis of a priority table of each operator (See FIG. 7, which will be described later) and the status table (See FIG. 10, which will be described later) indicating a status of each RFID label printer P, printer selection processing to select the RFID label printer P satisfying the operator's request information is carried out (for details, see FIG. 9, which will be described later).

At the subsequent Step S440, a signal corresponding to the request information obtained at Step S430 as a printing instruction signal is transmitted to the RFID label printer P selected at Step S500.

At the subsequent Step S445, a display signal is transmitted to the terminal PC to which the label production command signal has been transmitted through the interface control portion 201 and the communication line NW. As a result, display such as “Being produced by the printer Pₙ”, for example indicating the selected RFID label printer P is made on the display portion 101 of the terminal PC.

At the subsequent Step S450, it is determined if the production of the RFID label T has been finished or not. This determination is made by detecting if the RFID label production completion signal has been input from the RFID label printer P through the interface control portion 201 or not. If a production of the RFID label T is finished, the determination is satisfied, and the routine goes to the subsequent Step S455.

At Step S455, RFID label production history information (See FIG. 11, which will be described later) indicating which printer P has produced the RFID label T requested by each operator, that is, each terminal PC, stored in an appropriate storage device is updated. The appropriate storage device is the RAM 202C, for example, otherwise may be the data server DS.

At the subsequent Step S460, in the RFID label T produced by the RFID label printer P, combination of the RFID tag information including an ID as identification information written in the RFID tag circuit element To and a printing information printed by the print head 305 on a print area in response to that is output through the interface control portion 201 and stored in the data server DS. The stored data is stored and held in a database of the data server DS so that it can be referred to as necessary by the terminal PC.

At the subsequent Step S465, it is determined if power of the printer server PS has been turned OFF or not. If a power is not OFF, the determination is not satisfied, and the routine returns to the preceding Step S405. If it is determined that the power has been turned OFF, this flow is finished.

Note that the above flow does not limit the present invention to the procedure shown in the flow, but addition and deletion or change of order of procedures such as switching of the procedures of Step S455 and Step S460 to each other may be made within a range not departing from a gist and technical idea of the present invention.

The procedure at Step S430 in the above flow constitutes request an information acquisition portion configured to obtain the operator's request information contained in the printing operation signal described in each claim, the procedure at Step S500 constitutes an printer selecting portion configured to select a printer that can correspond to a tag attribute parameter or communication parameter of the RFID tag circuit element contained in the request information from among plurality of printers, and the procedure at Step S440 constitutes an instruction signal output portion configured to output a printing instruction signal corresponding to a printing operation signal to a printer selected by the printer selecting portion.

The procedure at Step S410 in the above flow constitutes an operation status information acquisition portion configured to obtain operation status information of the plurality of printers, and the procedure at Step S455 constitute a first update processing signal output portion configured to update and process the RFID label production history information by the printer. The procedure at Step S460 constitutes a second update processing signal output portion configured to update and process information in the database to the database storing at least tag correlation between identification information of the RFID tag circuit element and target information associated with the RFID tag circuit element, and the procedure at Step S445 constitutes a selection information output portion configured to output selection information corresponding to a selection result by the printer selecting portion to the operation terminal.

FIG. 7 conceptually illustrates a priority table.

In FIG. 7, the priority table is a table listing ranks of priorities of the RFID label printers P set in advance using a predetermined reference for each operator, that is, each terminal PC. In an example shown in FIG. 7, the priorities are set sequentially from the higher priority as printers P₄, P₁, P₃, P₂, . . . for the operator of the terminal PC₁. Also, the priorities are set sequentially from the higher priority as printers P₁, P₃, P₄, P₂, . . . for the operator of the terminal PC₂, and the priorities are set sequentially from the higher priority as printers P₃, P₂, P₁, P₄, . . . for the operator of the terminal PC₃.

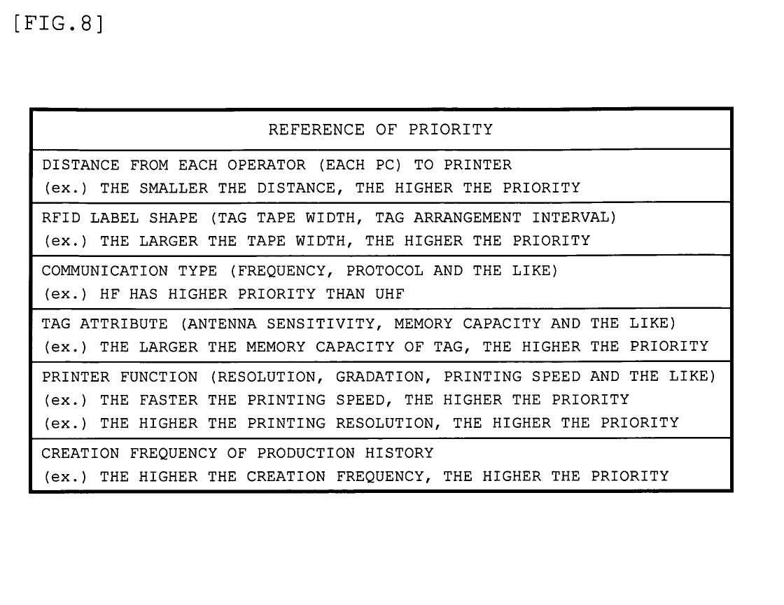

FIG. 8 conceptually illustrates reference items when priorities are set.

As shown in FIG. 8, reference items of priority include a distance of each RFID label printer P from the operator, that is, terminal PC as an example. Namely, a printer with a smaller distance from the operator, that is, the printer close to a seat, is given a higher priority. Another reference item of priority is a shape such as width, length of the RFID label T to be produced as an example. That is, if the operator wants to produce the RFID label T with as large width as possible, the printer with a larger tag tape width supplied from the attached cartridge 300 is given higher priority, while if the operator wants to produce the RFID label T as long as possible, the printer with a larger arrangement interval of the RFID tag circuit elements To in a tag tape supplied from the attached cartridge 300 is given higher priority.

Also, another reference item of priority is a type of radio communication such as communication frequency, communication protocol performed with the RFID tag circuit element To when the RFID label is produced as an example. That is, there is a case in which a HF tag is given higher priority than an UHF tag or a case in which the type C rather than type A of the ISO/IEC 18000-6 is given higher priority. Still another reference item of priority is an attribute such as antenna sensitivity, a memory capacity of the RFID tag circuit element To as an example. That is, the larger a capacity of the memory part 155 of the RFID tag circuit element To is, the higher priority is given.

Also, another reference item of priority is a function of a printer such as a resolution, a gradation, and a printing speed as an example. That is, there is a case in which the faster a printing speed is, the higher priority is given or a case in which the higher the printing resolution is, the higher priority is given. Still another reference item of priority is a use frequency of the printer obtained from a production history (See FIG. 11, which will be described later) as an example. That is, the higher the use frequency is, the higher priority is given.

FIG. 9 is a flowchart illustrating a detailed procedure of the above-described Step S500.

First, at Step S510, a variable N indicating a rank of priority of the RFID label printer P set in advance using the predetermined reference (See FIG. 8) for each operator, that is, each terminal PC is initialized to zero.

At the subsequent Step S520, one is added to the variable N, and the routine goes to the subsequent Step S530.

At Step S530, referring to the priority table (See FIG. 7) stored in an appropriate correlation storage device, the RFID label printer P with a priority N is specified, and printer information relating to a specification such as communication or printing functions of the specified printer P is obtained. The storage device is the RAM 202C, for example. Otherwise, the storage device may be the data server DS. The priority table is a table listing ranks of the priorities of the RFID label printers P set in advance using a predetermined reference for each operator, that is, each terminal PC, as described above. An example of the priority table is shown in the above-described FIG. 7, and in the example shown in FIG. 7, if a priority of the terminal PC₁, is set the higher for the printer located at a position the closer to the terminal, at Step S530, information of the RFID label printer P₄, which is the closest from the terminal PC₁, is obtained in the case of N=1 if the RFID label production command is given from the terminal PC₁. The printer information such as the specification of each RFID label printer P is registered in the data server DS in advance so that after the RFID label printer P with the priority N is specified, the data server DS is referred to and the information is obtained.

At the subsequent Step S540, the printer information of the RFID label printer P with the priority N obtained at Step S530 is compared with the operator's request information and it is determined if the RFID label printer P with the priority N satisfies the request information or not. If the operator's request is not satisfied, the determination is not satisfied, and the routine goes to the preceding Step S520. Then, one is added to the variable N, and the procedure at Step S530 and Step S540 is repeated for the RFID label printer P with the next priority N+1. On the other hand, if the operator's request is satisfied at Step S540, the determination is satisfied, and the routine goes to the subsequent Step S550.

Here, it is determined if the printer P can produce the desired RFID label T or not by getting the printer information of the printer P with the priority N and comparing it with the operator's request information, but not limited to that. That is, it may be so configured that when a template is selected at Step S425 in the above-described FIG. 7, an RFID label printer P group that can produce the RFID label T corresponding to the template is read of the appropriate storage device, and it is determined if the RFID label printer P with the priority N specified referring to the priority table is included in the RFID label printer P group or not. The RFID label printer P group includes at least one unit or might include plural units among the printers P₁ to Pₙ.

At Step S550, the status table (See FIG. 10, which will be described later) stored in the appropriate storage device is referred to, and the status information of the RFID label printer P with the priority N is obtained. The appropriate storage device is the RAM 202C, for example otherwise may be the data server DS.

At the subsequent Step S560, on the basis of the status information obtained at Step S550, it is determined if the RFID label printer P with the priority N can perform the RFID label production or not. An example of the status table is shown in FIG. 10, which will be described later, and in the example shown in FIG. 10, for example, in the case of the printer P₂, it is determined that the RFID label production is possible immediately, while in the case of the printer P₃, it is determined that the RFID label production is impossible. How to determine in the case of the printer P₁ or P₄ can be set for each operator, that is, terminal PC. For example, if a required time till job completion is longer than 1 minute, it may be determined that the label production is impossible, while if it is within 1 minute, it may be determined that the production is possible. If it is determined that the RFID label production is impossible, the routine returns to the preceding Step S520. On the other hand, if it is determined that the RFID label production is possible, the routine goes to the subsequent Step S570.

At Step S570, the RFID label printer P with the priority N is selected, and this flow is finished.

Note that the above flow does not limit the present invention to the procedure shown in the flow, but addition and deletion or change of order of procedures may be made within a range not departing from a gist and technical idea of the present invention.

FIG. 10 conceptually illustrates a status table.

In FIG. 10, the status table is a table consisting of information indicating an operation state of each printer P as described above. In an example shown in FIG. 10, the printer P₁ is in a state having a printing and communication job, that is, during RFID label production in which it has a job to produce remaining 3 pieces of RFID labels T, and time of approximately 2 minutes is required till the production of the labels is completed. The printer P₂ is in a state not having a job, and the RFID label production can be started immediately. The printer P₃ has finished supply of whole of the tag tape 303 from the roll 304 of a tape with RFID tags in the attached cartridge 300 and is in a state of tag tape shortage. The printer P₄ is in a state having a printing and communication job, that is, during RFID label production in which it has a job to produce a remaining single piece of the RFID label T and time of approximately 30 seconds is required till the production of the label is completed.

Here, using the example in above-described FIG. 7 and FIG. 10, a specific printer selection procedure in a printer selection processing shown in the above-described FIG. 9 will be described.

If the printer that has output the RFID label production command is the terminal PC₁, for example, the printer with the priority N=1 is the printer P₄ as shown in FIG. 7. That is, printer information of the printer P₄ is obtained at Step S530 in FIG. 9. If the printer P₄ satisfies the operator's request information, the determination at Step S540 is satisfied, the routine goes to Step S550, and the status information of the printer P₄ is obtained referring to the status table. As shown in FIG. 10, the printer P₄ has a job to produce a remaining single piece of RFID label T, and time of approximately 30 seconds is required till the label production is completed. At this time, suppose that the terminal PC₁, is set so that it is determined that the label production is impossible for those with a job. As a result, the determination at Step S560 is not satisfied, and the routine returns to Step S520, where the priority is set to N=2. As shown in FIG. 7, since the printer with the priority N=2 is the printer P₁, the printer information of the printer P₁ is obtained at Step S530 in FIG. 9. After that, the routine advances to Step S550 similarly to the above, and the status information of the printer P₁ is obtained referring to the status table. As shown in FIG. 10, the printer P₁ has a job to produce remaining three pieces of the RFID labels T, and time of approximately 2 minutes is required till the label production is completed. Therefore, the determination at Step S560 is not satisfied, and the routine returns to Step S520, where the priority is set to N=3. The similar procedure is repeated for the printer P₃ with the priority N=3. Since the status information of the printer P₃ is a tag tape shortage, the determination at Step S560 is not satisfied, and the routine returns to Step S520 again, and the priority is set to N=4. The similar procedure is repeated for the printer P₂ with the priority N=4, and since the status information of the printer P₂ is no job, the determination at Step S560 in FIG. 9 is satisfied, and the printer P₂ is finally selected at Step S570.

On the other hand, if the printer that has output the RFID label production command is the terminal PC₂, for example, the printer with the priority N=1 is the printer P₁ as shown in FIG. 7. That is, the printer information of the printer P₁ is obtained at Step S530 in FIG. 9. If the printer P₁ satisfies the operator's request information, the determination at Step S540 is satisfied, the routine goes to Step S550, and the status information of the printer P₁ is obtained referring to the status table. As shown in FIG. 10, the printer P₁ has the job to produce the remaining three pieces of RFID label T, and time of approximately 2 minutes is required till the label production is completed. At this time, suppose that the terminal PC₁ is set so that it is determined that the label production is impossible for those with a required time till job completion longer than 1 minute and the label production is possible for those with a required time within 1 minute. As a result, the determination at Step S560 is not satisfied, and the routine returns to Step S520, where the priority is set to N=2. Subsequently, the similar procedure is repeated for the printer P₃ with the priority N=2, and since the status information of the printer P₃ is the tag tape shortage, the determination at Step S560 is not satisfied, and the routine returns to Step S520 again, where the priority is set to N=3. Subsequently, the similar procedure is repeated for the printer P₄ with the priority N=3. The status information of the printer P₄ is such that, as shown in FIG. 10, it has the job to produce the remaining single piece of RFID label T and requires time of approximately 30 seconds till the label production is completed. Therefore, the determination at Step S560 in FIG. 9 is satisfied, and the printer P₄ is finally selected at Step S570.

On the other hand, if the printer that has output the RFID label production command is the terminal PC₃, for example, as shown in FIG. 7, the printer with the priority N=1 is the printer P₃. Since the status information of the printer P₃ is the tag tape shortage, the determination at Step S560 is not satisfied, and the routine returns to Step S520 again, where the priority is set to N=2. The similar procedure is repeated for the printer P₂ with the priority N=2, and since the status information of the printer P₂ is no job, the determination at Step S560 in FIG. 9 is satisfied, and the printer P₂ is finally selected at Step S570.

FIG. 11 conceptually illustrates an RFID label production history.

is a diagram illustrating an example of the above-described RFID label production history.

In FIG. 11, the RFID label production history is history information indicating which printer P produced the RFID label T requested by each operator, that is, each terminal PC stored in the appropriate storage device for each operator, that is, each terminal PC. The appropriate storage device is the RAM 202C, for example, otherwise may be the data server DS. In an example shown in FIG. 11, in the case of the terminal PC₁, for example, the printer with the largest number of production times is the printer P₄, while the printer with the smallest number of production times is the printer P₂. In the case of the terminal PC₂, for example, the printer with the largest number of production times is the printer P₁, while the printer with the smallest number of production times is the printer P₂. In the case of the terminal PC₃, for example, the printer with the largest number of production times is the printer P₃, while the printer with the smallest number of production times is the printer P₄.

In this embodiment described above, information transmission and reception is carried out via radio communication to the RFID tag circuit element To provided at the tag tape 303 through the antenna 306 of the RFID label printer P, and the corresponding printing is performed by the print head 305 on the tag tape 303 so that the RFID label T having a desired RFID tag information is produced. If the RFID label T is to be produced as above, other than needs relating to size and shape of a object to be printed and a printing mode such as color or monochromatic in the case of performing only printing by a regular printer not having a radio communication function, needs relating to communication types such as tag attributes of the RFID tag circuit element To, communication frequency and protocol are added, which makes needs of an operator further diversified. Thus, the above-described problem of the prior art reference that requires labor when an operator selects an optimal printer for his or her needs becomes further remarkable.

Here, in this embodiment, when the operator selects a desired template from among a plurality of templates, the printer P that can deal with tag attributes of the RFID tag circuit element To provided at the RFID label T to be produced or communication type is automatically selected. As a result, the RFID label printer P having the antenna 306 that can communicate with the tag attributes and communication type suitable for the RFID tag circuit element To of the RFID label T to be produced can be selected so as to produce the RFID label T. With the arrangement, according to this embodiment, a printer suitable for the needs relating to radio communication of the operator can be automatically selected from among the plurality of RFID label printers P. As a result, a labor when the operator selects the RFID label printer P can be drastically reduced.

Also, particularly in this embodiment, the RFID label printer P is selected according to the priority order of the plurality of printers set in advance for each operator, that is, each terminal PC. As a result, by setting the priority order of the plurality of RFID label printers P in advance according to the operator's needs, a printer further suitable for the operator's needs can be automatically selected.

Also, particularly in this embodiment, a corresponding printer among the plurality of RFID label printers P is selected according to the needs relating to the operator's RFID label production, the needs being request information set by selection by the operator of a desired template from among a plurality of templates, and status information indicating an operation status of each RFID label printer P. As a result, if the RFID label printer P satisfying request information of the operator is in a malfunctioning state due to some cause, for example, or in a busy state since it has a printing job from another operator, the printer is avoided and another RFID label printer P can be selected. As a result, the label production can be carried out rapidly, and an operating efficiency of the plurality of RFID label printers P can be improved.

Also, particularly in this embodiment, the status information includes information on whether the RFID label printer P is during an RFID label production or not and information on remaining time till a job is finished in the case of during the production. As a result, if a remaining time till the label production operation is finished of the RFID label printer P in accordance with the operator's needs is larger than a predetermined time, the printer is avoided and another printer can be selected, while if the remaining time is not more than a predetermined time, the printer can be selected, which realizes finer control.

Also, particularly in this embodiment, when the operator selects the desired template, the RFID label printer P that can produce a shape such as width, length of the desired RFID label T can be selected. As a result, a printer suitable for the needs relating to the shape of the operator's RFID label T can be automatically selected from among a plurality of the RFID label printers P.

Also, particularly in this embodiment, when the operator selects the desired template, the RFID label printer P that can produce the RFID label T having at least one of desired antenna sensitivity, namely sensitivity of the antenna 151 of the RFID tag circuit element To, and a desired memory capacity, namely memory capacity of the IC circuit part 150 of the RFID tag circuit element To, can be selected. As a result, a printer suitable for the needs relating to the tag attributes of the RFID tag circuit element To of the RFID label T to be produced can be automatically selected.

Also, particularly in this embodiment, when the operator selects the desired template, a printer that can produce the RFID label T by performing radio communication corresponding to at least one of a desired electromagnetic wave frequency used for the radio communication and a desired communication protocol can be automatically selected. As a result, a printer suitable for the needs relating to the communication type of the radio communication performed in production of the RFID label T can be automatically selected.

Also, particularly in this embodiment, each time the production of the RFID label T is completed by each RFID label printer P, RFID label production history information indicating which printer P produced the RFID label T requested by each operator, that is, each terminal PC is updated. As a result, it is possible to check an operating state of each RFID label printer P by referring to the production history information for every predetermined period, for example.

Also, particularly in this embodiment, each time the production of the RFID label T is completed by each RFID label printer P, combination as correlation information of the RFID tag information including an ID as identification information written in the RFID tag circuit element To and printing information printed on the print area by the print head 305 in response thereto is stored in the data sever DS. As a result, when the RFID label T produced by the RFID label printer P is used, correlation information stored in the data sever DS is referred to on the basis of the ID of the RFID tag circuit element To of the RFID label T read by the reader and the information, such as printing information associated with the RFID tag circuit element To can be obtained.

Also, particularly in this embodiment, a display signal is transmitted to the terminal PC when the printer is selected so that the selected RFID label printer P is displayed on the display portion 101 of the terminal PC. As a result, the operator can recognize by which printer among a plurality of RFID label printers P the RFID label T requested from each terminal PC is to be produced.

Note that the present invention is not limited to the above embodiment but is capable of various variations within a range not departing from its gist and technical idea. Variations will be described below in order.

(1) A case that a template display is not made:

In the above embodiment, when the operator selects a desired template from among the plurality of templates displayed on the display portion 101 of the terminal PC, the operator's request information such as shape, communication type, tag attributes, printing mode, relating to the RFID label production is determined, and the RFID label printer P corresponding to the request information is selected in the printer server PS, but not limited to that. That is, it may be so configured that without selection by the operator of the template, only by transmitting the label production command signal from the terminal PC, the optimal RFID label printer P is selected on the basis of a signal received by the printer server PS.

In this case, it is only necessary that the label production command signal first output from the terminal PC when the RFID label production is to be started includes the request information of the RFID label T, such as shape, communication type, tag attributes, printing mode. Particularly, with regard to the request information relating to the printing mode, the printing mode produced by the operator in the terminal PC may be included in the label production command signal as image data as it is so that the printer server PS analyzes an image data and selects the printer having a required printing function such as resolution, gradation.

According to this variation, since labor to select the template can be saved, the labor when the operator selects the RFID label printer P can be further reduced.

(2) Others

In the above, the case in which in the RFID label printer P, the tag tape 303 for which printing and an access, that is reading or writing, to the RFID tag circuit element To are finished is cut off with the cutter 307 so as to produce the RFID label T is described as an example, but not limited to that. That is, if label mounts such as so-called die-cut labels, separated in advance to a predetermined size corresponding to the label are sequentially arranged on the tape fed out of the roll, the RFID label T may be produced by peeling off only the label mount from the tape after the tape is discharged from the carry-out exit 16 without cutting it by the cutter 307. The accessed RFID tag circuit element To is provided at the label mount and the corresponding printing has been performed. Thus, the present invention can also be applied to such a case.

Also, in the above, a method according to so-called non-bonding type is employed in which a printing is performed on the print receiving tape layer provided at the tag tape 303, but not limited to that, the present invention may be applied to a method of bonding by performing a printing on a cover film separate from a base tape provided with the RFID tag circuit element To. Moreover, the present invention is not limited to the reading or writing of the RFID tag information with respect to the IC circuit part 151 of the RFID tag circuit element To and the printing for identifying the RFID tag circuit element To by the print head 305. This printing does not necessarily have to be performed, and the present invention can also be applied to the one for which the RFID tag information is read or written.

Moreover, in the above, the case in which the roll 304 of a tape with RFID tags includes winding the tag tape 303 around a reel member, the roll 304 of a tape with RFID tags is arranged in the cartridge 300 and the tag tape 303 is fed out thereof is described as an example, but not limited to that. For example, a lengthy flat sheet or strip state tape or sheet, the sheet including those formed by cutting it to an appropriate length after the tape wound around a roll is fed out, on which at least one RFID tag circuit element To is arranged is stacked in a predetermined storage portion and flatly stacked in a tray-like container, for example to be made into a cartridge, and the cartridge may be attached to a cartridge holder on the side of the apparatus 2 for producing an RFID label so that transfer and feeding are made from a storage portion for the printing and writing and the RFID label is produced.

Moreover, there may be such configurations that the roll 304 of a tape with RFID tags is directly attached to the RFID label printer P detachably or a lengthy flat sheet or strip state tape or sheet is transferred from outside the RFID label printer P one by one and supplied into the RFID label printer P by a predetermined feeder mechanism, or furthermore, not even limited to those detachably attached on a side of the RFID label printer main body such as the cartridge 300, the roll 304 of a tape with RFID tags may be provided as a so-called installed type or integral type non-detachably attached to a side of an apparatus main body. In this case, too, the same effect can be obtained.

The “Verify” command signal and the Program” command signal used in the above shall comply with the specification formulated by EPC global. The EPC global is a non-profit corporation jointly established by International EAN Association, which is an international organization of distribution codes, and UCC, that is, Uniformed Code Council, which is an U.S. distribution code organization. Signals complying with other standards will do as long as they serve the same functions.

Other than those as described above, methods of the embodiments and each variation may be combined as appropriate for use.

Though not specifically exemplified, the present invention should be put into practice with various changes made in a range not departing from its gist.

What is claimed is:

1. A printer controller configured to control a plurality of printers and connected to said plurality of printers and at least one operation terminal, said operation terminal outputting a printing operation signal, each of said printers having a printing device configured to perform printing of print data on an object to be printed and a communication device configured to carry out information transmission and reception via radio communication with an radio frequency identification (RFID) tag circuit element, said RFID tag circuit element including an IC circuit part storing information and a tag antenna for information transmission and reception provided at said object to be printed or a tag medium associated the object to be printed, comprising:
a request information obtainment portion configured to obtain request information of an operator included in said printing operation signal;
a printer selecting portion configured to select a printer that can deal with a tag attribute parameter or a communication parameter of said RFID tag circuit element included in said request information obtained by said request information obtainment portion, among said plurality of printers; and
an instruction signal output portion configured to output a printing instruction signal corresponding to said printing operation signal to the printer selected by said printer selecting portion.

2. The printer controller according to claim 1, wherein:
said printer selecting portion selects said printer according to a priority determined in advance for said plurality of printers.

3. The printer controller according to claim 2, further comprising a correlation storage device configured to store rank correlation relating to said priority set for each of a plurality of said operation terminals.

4. The printer controller according to claim 2, further comprising an operation status information obtainment portion configured to obtain operation status information of said plurality of printers, wherein
said printer selecting portion selects a corresponding printer among said plurality of printers according to said request information and said operation status information obtained by said operation status information obtainment portion.

5. The printer controller according to claim 4, wherein:
said operation status information obtainment portion obtains, as said operation status information, at least one of information indicating if said printer is during a printing operation to said object to be printed and a remaining time information till the printing operation on said object to be printed by said printer is finished.

6. The printer controller according to claim 1, wherein:
said printer selecting portion gives priority to said printer that can deal with object information relating to a shape of said object to be printed included in said request information so as to select the printer.

7. The printer controller according to claim 1, wherein:
said printer selecting portion gives priority to said printer that can deal with at least one of sensitivity of said tag antenna of corresponding said RFID tag circuit element, a memory capacity of said IC circuit part, and an arrangement interval of the RFID tag circuit elements on said object to be printed or said tag medium, as said tag attribute parameter, so as to select the printer.

8. The printer controller according to claim 1, wherein:
said printer selecting portion gives priority to said printer corresponding to at least one of a frequency of an electromagnetic wave and a communication protocol, used for said radio communication, as said communication parameter, so as to select the printer.

9. The printer controller according to claim 1, further comprising a first update processing signal output portion configured to perform update processing of RFID label production history information in accordance with production of an RFID label by said printer, the printer producing said RFID label by using said object to be printed or said tag medium for which printing by said printing device and information transmission and reception with respect to said RFID tag circuit element by said communication device have been carried out.

10. The printer controller according to claim 1, further comprising a second update processing signal output portion configured to perform update processing of information in a database storing at least tag correlation between identification information of said RFID tag circuit element and target information associated with said RFID tag circuit element in accordance with production of an RFID label by said printer, the printer producing said RFID label by using said object to be printed or said tag medium for which printing by said printing device and information transmission and reception with respect to said RFID tag circuit element by said communication device have been carried out.

11. The printer controller according to claim 1, further comprising a selection information output portion configured to output selection information corresponding to a selection result by said printer selecting portion to said operation terminal.
